(19) United States
(12) Patent Application Publication
(10) Pub. No.: US 2012/0300046 A1
(43) Pub. Date: Nov. 29, 2012

(54) Method and System for Directed Light Stereo Display

(76) Inventor: Ilya Blayvas, Ramat Gan (IL)

(21) Appl. No.: 13/114,772

(22) Filed: May 24, 2011

(51) Int. Cl. H04N 13/04

(52) U.S. Cl. 348/54; 348/51; 348/E13.026

(57) ABSTRACT

A plurality of perception directions associated with a viewer may be determined in a video device, and display of video content via the video device may be controlled based on the determined plurality of perception directions. Controlling display of the video content may comprise adaptively and/or separately configuring display of the content in each of the plurality of perception directions. The plurality of perception directions may be determined based on positioning information associated with the viewer. The positioning information may be determined using one or more sensors. The positioning information may comprise information pertaining to location and/or angle of perception associated with each of left eye and right eye of the viewer relative to the location and/or orientation of video device relative to the video device. The plurality of perception directions may comprise perception directions corresponding to each of right eye and left eye of the viewer.

### CLAIM OF PRIORITY

[Not Applicable].

### CROSS-REFERENCE TO RELATED APPLICATIONS/INCORPORATION BY REFERENCE

[Not Applicable].

### FEDERALLY SPONSORED RESEARCH OR DEVELOPMENT

[Not Applicable].

### [MICROFICHE/COPYRIGHT REFERENCE]

[Not Applicable].

### FIELD OF THE INVENTION

Certain embodiments of the invention relate to video processing. More specifically, certain embodiments of the invention relate to a method and system for directed light stereo display.

### BACKGROUND OF THE INVENTION

Various devices can be used to display video and/or multimedia content. Such video display devices may comprise dedicated display devices, such as televisions (TVs) and/or devices with display capabilities, such as smartphones, tablet devices, laptops, personal computers (PCs), and/or business (industrial or medical) devices with display screen for outputting data. The video display devices may display video corresponding to content that may be generated and/or provided locally, using localized audiovisual (AV) feeds for example; and/or the content may be streamed, via TV broadcasts and/or broadband telecasts, for example. In this regard, video content may be stored into, and/or read from storage devices, such as Digital Video Discs (DVDs) and/or BluRay discs, using player devices, such as DVD or BluRay players. Video content may also be communicated via streams, which may comprise TV broadcasts and/or broadband telecasts. Furthermore, in addition to video content obtained from broadcasts and/or locally from storage devices and/or memory, some video content may be associated with use of video interactive interfaces, such as during use of computers, smartphone, and/or game-console/video games, and as such the video content may be interactively generated.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for directed light stereo display, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video device that may support directed stereo display, in accordance with an embodiment of the invention.

FIG. 2 is a block diagram illustrating components of an exemplary video device that may support directed stereo display, in accordance with an embodiment of the invention.

FIG. 3A is a block diagram illustrating an exemplary video processing subsystem of a video device that may support directed stereo display, in accordance with an embodiment of the invention.

FIG. 3B is a block diagram illustrating an exemplary user locator subsystem of a video device that may support directed stereo display, in accordance with an embodiment of the invention.

FIG. 3C is a block diagram illustrating an exemplary screen which may support directed stereo display operations, in accordance with an embodiment of the invention.

FIG. 4 is a block diagram that illustrates an exemplary use of a micro-lens element in a directed stereo display capable screen to provide directional light emissions, in accordance with an embodiment of the invention.

FIG. 5 is a flow chart that illustrates exemplary steps for performing directed light stereo display, in accordance with an embodiment of the invention.

### DETAILED DESCRIPTION OF THE INVENTION

Certain embodiments of the invention may be found in a method and system for directed light stereo display. In various embodiments of the invention, a video device may detect presence of viewers of displayed video content handled via the video device, and may determine positioning information associated with each of the detected viewers. Presence of viewers may be detected either directly, such as by means of scanning techniques for example; or indirectly, such as based on viewer's actions for example. The viewer positioning information may comprise information specifying viewer location, distance, and/or orientation, relative to a location of the video device. The viewer positioning information may comprise information associated with each of left and right eyes of viewer, which may comprise information pertaining to location and/or angle of perception associated with each eye relative to the video device. The video device may determine a plurality of perception directions associated with each viewer, and display of video content via the video device may be controlled based on the determined plurality of perception directions. In this regard, the display of the video content may be adaptively controlled based on changes to one or more of the determined plurality of the perceived locations. Furthermore, controlling display of video content via the video device may also comprise adaptively configuring display of video content separately in each of the plurality of perception directions.

Viewer positioning information may be determined, and/or spatial and/or temporal movement of viewers may be tracked based on information generated by one or more sensors integrated into and/or coupled to the vide device. The one or more sensors may comprise a pair of stereoscopic cameras. The plurality of perception directions may comprise perception directions corresponding to each of the right eye and the left eye of viewer relative to the location and/or orientation of the video device, which may be determined based on positioning information associated with the viewer's eyes. In this regard, controlling display of video content via the video device may comprise adaptively and/or separately controlling display of that video content in each of the perceptions perception directions associated with the left eye and right eye of the viewer.

Three-dimensional (3D) perception may be formed by displaying separate sequences of frames or fields associated with each of viewer's left and right eye via appropriate corresponding perception directions. For two-dimensional (2D) video content, display operation may be configured to convey identical video content in each of the perception directions associated with that viewer's right and left eyes, to form 2D perception. Spatial and/or temporal movement of the detected viewer relative to the location of video device may be tracked continually, and corresponding viewer position information are modified based on that tracking of spatial and/or temporal movement of the viewer such that video display operation may be reconfigured and/or adjusted based on any changes in viewers positioning information.

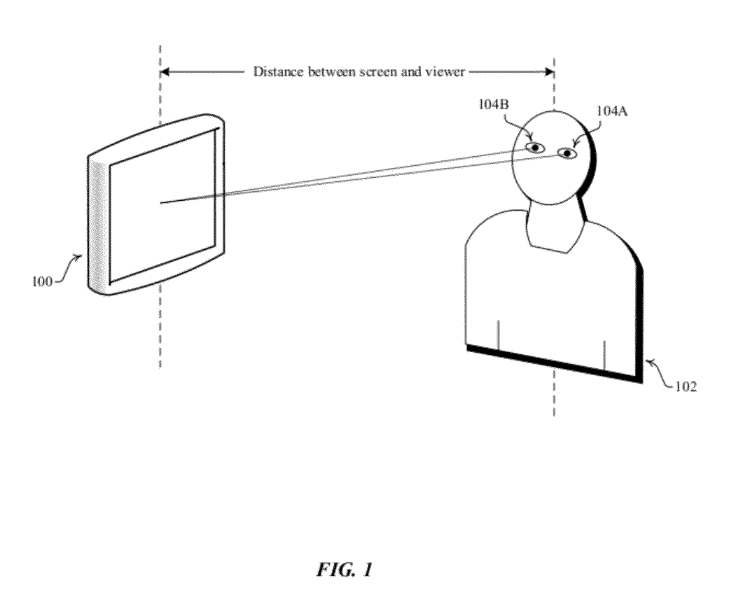

FIG. 1 is a block diagram illustrating an exemplary video device that may support directed stereo display, in accordance with an embodiment of the invention. Referring to FIG. 1, there is shown a video device 100 and a user 102.

The video device 100 may comprise suitable logic, circuitry, interfaces, and/or code that may be operable to display video content, which may include three-dimensional (3D) video, and outputting additional related information and/or data, such as audio for example. The video content may be displayed via a display that may be integrated into and/or coupled to the video device 100. The video device 100 may comprise a smartphone, a tablet, a laptop, a personal computer (PC), or a television (TV). The video device 100 may also comprise a set-top box (STB), a media player (such as DVD or BluRay player), and/or other similar devices that maybe coupled to external display device such as a monitor or a TV through which the video content is displayed. In an exemplary aspect of the invention, the video device 100 may support displaying 3D video content autonomously, without requiring use of auxiliary devices to facilitate 3D perception, such specialized optical viewing devices (3D glasses) for example.

In operation, the video device 100 may be operable to display video content, which may be read from storage devices, downloaded, for example from the Internet, and/or streamed to the video device 100, such as via over-the-air and/or online broadcasts. In this regard, the video content displayed via the video device 100 may comprise two-dimensional (2D) video and/or three-dimensional (3D) video. In this regard, multimedia content handled by the video device 100 may be outputted as 3D video, which may be more desirable since 3D perception is more realistic to humans.

Various techniques may be utilized to capture, generate (at capture and/or playtime) and/or render 3D video images. For example, one common technique for implementing 3D video is stereoscopic 3D video. In stereoscopic 3D video based applications the 3D video impression may be generated by rendering multiple views, most commonly two views: a left view and a right view, corresponding to viewer's left eye and right eye, to give depth to displayed images. The left view and the right view sequences may be captured and/or processed to enable the creation of 3D images. The video data corresponding to the left view and right view sequences may then be communicated either as separate streams, or may be combined into a single transport stream and would be separated into different view sequences by the end-user receiving/displaying device. The 3D video content may communicated via broadcasts, such as TV and/or broadband broadcasts, and/or by use of multimedia storage devices, such as DVD or Blu-ray discs, which may be utilized to store 3D video data that may subsequently be played back. Various compression/encoding standards may be utilized to enable compressing and/or encoding of the view sequences into transport streams during communication of 3D video content. For example, in instances where stereoscopic 3D video is utilized, the separate left and right view sequences may be compressed based on MPEG-2 MVP, H.264 and/or MPEG-4 advanced video coding (AVC) or MPEG-4 multi-view video coding (MVC).

The video device 100 may be operable to receive and/or process video contents, which may comprise 2D as well as 3D video content, and to display corresponding images and/or streams to viewers, such as the user 102. The 3D content handled by the video device 100 may comprise, for example, stereoscopic 3D video. In this regard, the video device 100 may be operable to decode the encoded stereoscopic 3D video sequences, and generated corresponding video output streams for display that may create 3D perception. 3D viewing may typically require use of, in conjunction with 3D-capable display devices, auxiliary devices such as specialized glasses for enabling 3D perception (or 3D glasses), which must be worn by users, such as user 102, to enable creating the required 3D perception. In this regard, in instances where the displayed video content comprises stereoscopic 3D video content, which may comprise left and right view sequences, 3D glasses may be utilized to enable 3D perception by providing independent image perception by user's left and right eyes such that the combined effects may generate 3D perception. These “3D glasses” may comprise auxiliary glasses, which may operate either based on synchronization or polarization techniques. With synchronization based glasses, the glasses may incorporate shutters, or similar means for adjusting viewing transparency, for the right and left eyes. The operation of the shutters (i.e. closing and opening) may be synchronized with operations of the associated display device. In this regard, the display device sequentially alternates between right and left eye image streams, and the glasses right and left eye shutters open and close accordingly to enable viewing by only the left eye when left eye images are displayed and by only the right eye when right eye images are displayed. With polarization based glasses, the glasses may incorporate polarized filters for each of the eyes, such as with vertical polarization for one eye and horizontal polarization for another eye, and/or color spectrum separated streams. The associated display device may then be configured to display concurrently different view streams for each of the right and left eyes, with each of the view streams being viewable only via one of the polarized filters and completely blocked by the other polarized filter.

In various embodiments of the invention, the video device 100 may support autonomous 3D video display operations, in which 3D perception may be generated and/or formed without necessitating the use of auxiliary external devices in conjunction with the video device 100, such as 3D glasses. Autonomous 3D viewing may be achieved, for example, by use of directed stereo display techniques. In this regard, during directed stereo display operations, the video device 100 may be operable to create a plurality of different visual perceptions associated with a corresponding plurality of spatial directions relative to the location and/or orientation of video device 100. For example, the display (or screen) of video device 100 may be configured to form, based on video content that is to be displayed, a plurality of perception views, each of which is associated with a different spatial direction (or viewing angles) relative to the location of the video device 100 (or screen thereof). The plurality of perception views may be utilized to convey, at the same time, different sequences of images. Also, during directed stereo display, the directional perception views may be generated and/or displayed at the same time. In this regard, the plurality of directional perception views may be utilized to create 3D perception by a user, such as user 102, by correlating two of these directional perception views with each of the left eye 104A and the right eye 104B of user 102.

Accordingly, 3D perception may be formed based on separate perceived image sequences conveyed via the directional perception views, corresponding to viewers' left eye and right eye image sequences, which may be displayed and perceived at the same time by each of the left eye 104A and the right eye 104B. This may be more desirable than video display systems that may achieve 3D perception by use of auxiliary viewing devices (e.g. 3D glasses) and/or by alternating, for example, between displaying right eye images and left eye images. in other words, video display operations in the video device 100 may be configured during directed stereo display operations such that each of the left eye 104A and the right eye 1048 can concurrently perceive different images, without requiring use of auxiliary viewing devices, with images directed at the left eye 104A being viewable only by the left eye 104A and images directed at the right eye 104B being viewable only by the right eye 104B.

In an exemplary embodiment of the invention, separate directional perceptions during directed stereo display operations may be achieved by utilizing variable light emitting techniques. In this regard, a screen of video device 100 may be designed, manufactured, and/or configured to comprise a plurality of elements, and for each screen “element” separate visual effects (and thus perception) may be created at different spatial directions relative to the screen. The screen elements may correspond to small portions of the screen, for each of which display operations may be controlled and/or configured separately. The number and/or distribution of screen elements may correspond to the maximum display resolution supported by, and/or associated with the screen of the video device 100. For example, in a screen that may support, for example, a maximum display resolution corresponding to video format 1080p (full HDTV), the screen may be configured to comprise 1920×1080 screen elements. In this regard, each of the 1920×1080 screen elements may be configured to created different viewing perceptions associated with different viewing directions relative to the screen. Accordingly, the screen elements may be configured based on the position of the user 102 relative to the screen of video device 100. The screen elements may be configured to create different viewing perceptions for each of the left eye 104A and the right eye 1048 during display of each video frame (or field) of the video content.

Use of directed stereo display techniques may be desirable because it eliminates the need to use (by viewers) of special auxiliary devices, such as 3D glasses, to form the 3D perception, and/or requiring performing of necessary synchronization operations to coordinate operations of the video display and such auxiliary devices. In addition, use of directed stereo display techniques may enhance privacy because images are only displayed to particular viewer's eyes while the screen may appear blank to others who may be viewing the screen from different directions. Furthermore, use of directed stereo display techniques may optimize energy consumption. This may be achieved by reducing energy used for display operations since images are formed directionally, only in specific and/or narrow directions, rather than omnidirectionally, and thus light emissions from the screen are configured to be sent only in particular narrow directions, towards authorized viewers' eyes rather than being emitted in all the directions.

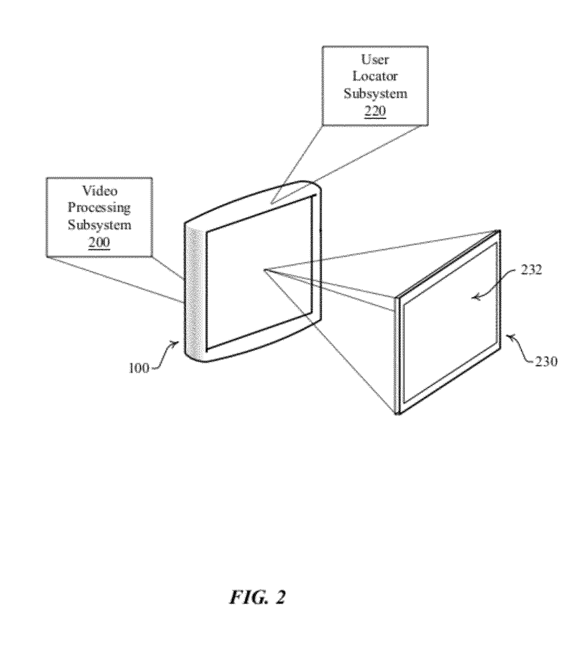

FIG. 2 is a block diagram illustrating components of an exemplary video device that may support directed stereo display, in accordance with an embodiment of the invention. Referring to FIG. 2, there in shown video device 100 of FIG. 1. The video device 100 may comprise a video processing subsystem 200, a user locator subsystem 220, and a display subsystem 230.

The video processing subsystem 200 may comprise suitable logic, circuitry, interfaces and/or code that may enable processing of video content, and/or generating video playback streams based thereon for display, via the display subsystem 230 for example. In an exemplary aspect of the invention, the video processing subsystem 200 may support autonomous 3D video display operations, utilizing directed light stereo display.

The user locator subsystem 220 may comprise suitable logic, circuitry, interfaces and/or code that may be operable to detect users of video device 100, and/or to generate and/or modify positional information associated therewith. In this regard, the user locator subsystem 220 may be operable to search for and/or locate users, such as the user 102, and/or may also be operable to continue tracking, spatially and/or temporally, movement of detected users. In this regard, presence of viewers may be detected either directly, such as by means of scanning techniques and/or by use of sensors for example; or indirectly, such as based on user actions for example. Exemplary user actions that may enable determining presence of users may comprise interacting with the video device 100, such as by pressing buttons and/or by physically rotating or moving the video device 100, such as when the video device 100 comprises a smartphone for example. The positional information may comprise information pertaining to location and/or orientation of users, relative to the display subsystem 230 (or screen therein). In this regard, the location information may be determined in terms of distance from the center of the screen, and/or in terms of angle relative to perpendicular line through the center of the screen. In an exemplary aspect of the invention, the positional information may also comprise additional information that may be necessary for directed stereo display operations. For example, the positional information may comprise information pertaining to location and/or orientation of each of the viewers' eyes relative to the screen.

The display subsystem 230 may comprise suitable logic, circuitry, interfaces and/or code that may enable displaying of video content, which may be handled and/or processed via the video processing subsystem 200. In an exemplary aspect of the invention, the display subsystem 230 may comprise a screen that may be configured for support of directed light stereo display operations. In this regard, the screen 232 may comprise a plurality of elements (screen elements), each of which may be configured to create based on video content, different viewing perceptions corresponding to different viewing angles relative to the screen 232. The number and/or distribution of screen elements may be determined based on the display resolution associated with screen 232. For example, in instances where the screen 232 supports a maximum display resolution corresponding to video format 1080p (full HDTV), the screen 232 may comprise 1920×1080 screen elements.

While the video processing subsystem 200, the user locator subsystem 220, and the display subsystem 230 are shown in FIG. 2 as being integrated into a singular device, the invention need not be so limited. In this regard, the video processing subsystem 200, the user locator subsystem 220, and the display subsystem 230 may be divided into separate external devices coupled to each other to form the video device 100. For example, video processing subsystem 200 may be integrated into a set-top box (STB) or DVD player, whereas the user locator subsystem 220 and the display subsystem 230 may be integrated into a television that is coupled to that STB or DVD player.

In operation, the video device 100 may support autonomous 3D video display operations, in which 3D perception may be created without necessitating use of auxiliary devices such as 3D glasses. For example, the video device 100 may enable autonomous 3D viewing by use of directed stereo display via screen 232 of the display subsystem 230. In this regard, during directed stereo display operations, the screen 232 of the display subsystem 230 may be configured to form concurrent separate image perceptions corresponding to different viewing directions or angles relative to the screen 232. The different viewing perceptions may be associated with each of the left eye 104A and the right eye 104B of user 102 for example. This may enable creating different views that would result in 3D perception. Creating varied and/or independent view perceptions at different spatial directions may be achieved by utilizing variable light emitting techniques in the screen 232. In this regard, the screen 232 may be configured such that at least some of the screen elements therein may create different viewing perceptions associated with different viewing directions relative to the screen 232. The screen elements of the screen 232 may be configured based on the location of the user 102 relative to the location and/or orientation of the screen 232. In this regard, the user locator subsystem 220 may be utilized to search for and/or detect presence of users of the video device 100. Furthermore, the user locator subsystem 220 may be utilized to continue tracking movement of detected users, to enable continuously determining changes in users' positions relative to the location and/or orientation of the screen 232. The user locator subsystem 220 may also be operable to generate and/or modify positional information associated with each detected user.

In an exemplary embodiment of the invention, the video device 100 may support concurrent use of multiple users (i.e. multiple viewers of video contents). In this regard, the viewer locator subsystem 220 may be operable to detect, track, and/or generate positioning information associate with multiple viewers at the same time. Furthermore, the video processing subsystem 200 may be operable to configure and/or generate, based on the viewers positioning information, video content associated with each of the multiple viewers, and the display subsystem 230 may be operable to form, based on processed video content, spatial directional perception views associated with each of the multiple viewers. For example, the display subsystem 230 may be operable to form concurrent directional perception views associated with each of the left eye and right of each of the multiple viewers.

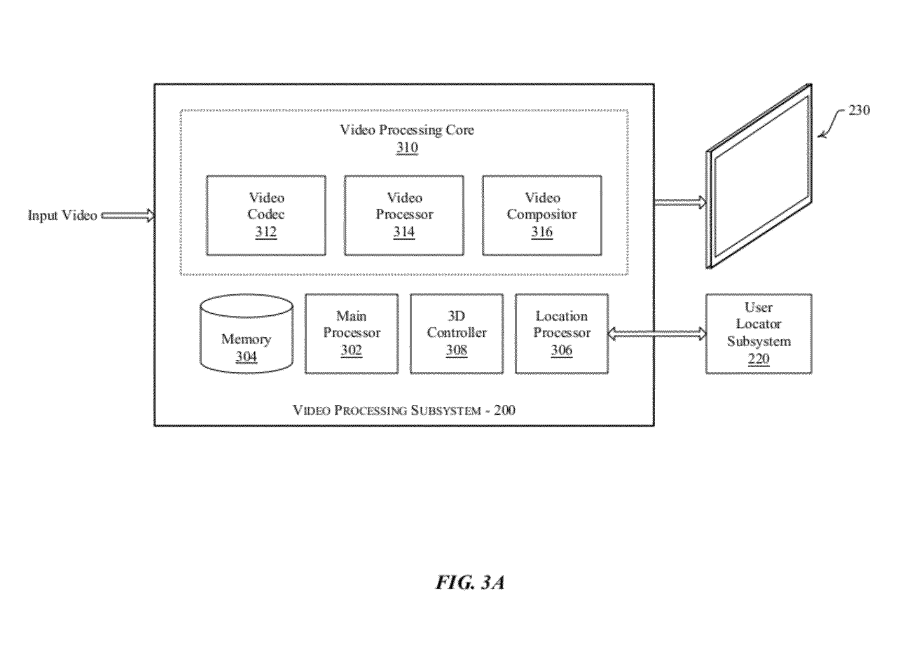

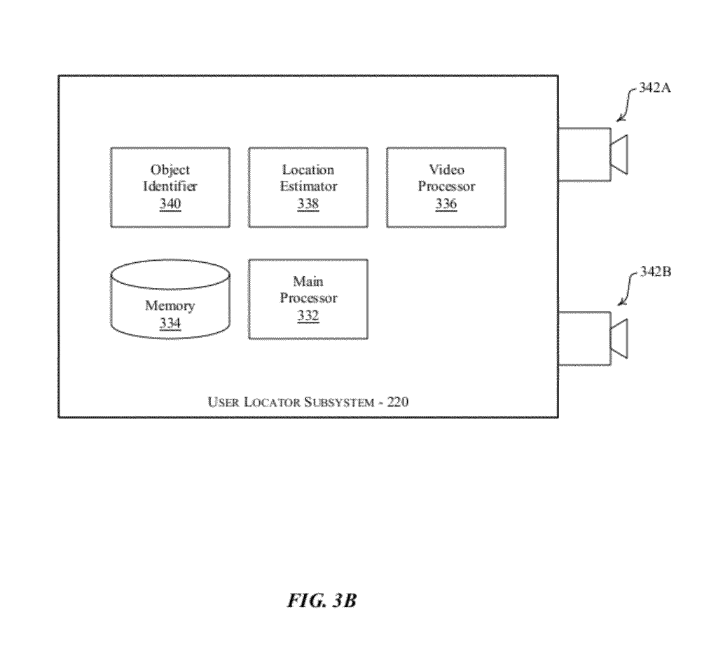

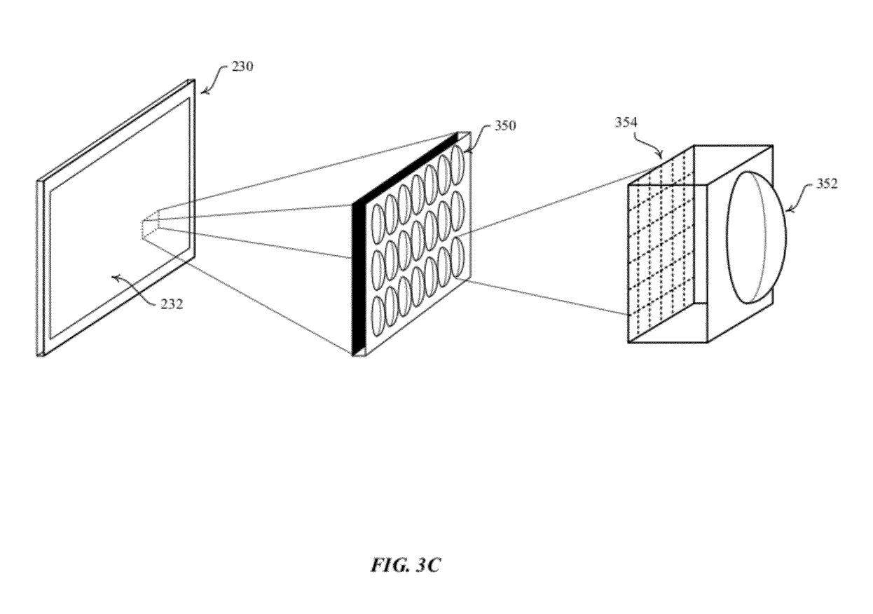

FIG. 3A is a block diagram illustrating an exemplary video processing subsystem of a video device that may support directed stereo display, in accordance with an embodiment of the invention. Referring to FIG. 3, there is shown the video processing subsystem 200, the user locator subsystem 220, and the display subsystem 230.

The video processing subsystem 200 may comprise a main processor 302, a system memory 304, a location processor 306, a 3D controller 308, and a video processing core 310. In an exemplary aspect of the invention, the video processing subsystem 200 may support autonomous 3D video display operations, utilizing directed light stereo display, substantially as described with regard to FIG. 2. In this regard, the video processing subsystem 200 may be integrated into the video device 100, for example, to enable generating, displaying, and/or controlling 3D video display operations.

The main processor 302 may comprise suitable logic, circuitry, interfaces and/or code that may be operable to process data, and/or control and/or manage operations of the video processing subsystem 200, and/or tasks and/or applications performed therein. In this regard, the main processor 302 may be operable to configure and/or control operations of various components and/or subsystems of the video processing subsystem 200, by utilizing, for example, one or more control signals. The main processor 302 may also control data transfers within the video processing subsystem 200. The main processor 302 may enable execution of applications, programs and/or code, which may be stored in the system memory 304, for example.

The system memory 304 may comprise suitable logic, circuitry, interfaces and/or code that may enable permanent and/or non-permanent storage, buffering and/or fetching of data, code and/or other information which may be used, consumed and/or processed in the video processing subsystem 200. In this regard, the system memory 304 may comprise different memory technologies, including, for example, read-only memory (ROM), random access memory (RAM), Flash memory, solid-state drive (SSD) and/or field-programmable gate array (FPGA). The system memory 304 may store, for example, configuration data, which may comprise parameters and/or code, comprising software and/or firmware, but the configuration data need not be limited in this regard.

The location processor 306 may comprise suitable logic, circuitry, interfaces and/or code that may be operable to process user location and/or tracking related information, to enable generation of user related data that may be utilized during display operations, such as during directed stereo display operations. In this regard, the location processor 306 may be operable to process positioning information associated with one or more viewers associated with the video device 100, viewing video content handled via the video processing subsystem 200. The positioning information may be obtained from the user locator subsystem 220. Processing of positioning information via the location processor 306 may enable determining the location of viewers, or at least certain parts thereof such as viewer's eyes, relative to the screen 232 of the display subsystem 230. In this regard, relative location may refer to distance from the center of the screen 232 and/or angle of viewing with respect to the perpendicular line through the center of the screen 232. This may enable determining viewing directions relative to the screen, which may be optimal for perception by each of the viewers' eyes.

The 3D controller 308 may comprise suitable logic, circuitry, interfaces and/or code that may be operable to generate control information that may be utilized in managing and/or configuring display operations to facilitate 3D perception, which may be performed based on directed stereo display techniques. In this regard, the 3D controller 308 may be operable to set and/or adjust video related information, such as brightness and/or color related information, pertaining to separate views, which may comprise left view and right view corresponding to user's left eye and right eye. In other words, the 3D controller 308 may be operable to determine how to generate separate views, which when perceived concurrently, may create a 3D perception of display video content. In an exemplary aspect of the invention, the 3D controller 308 may also incorporate control information pertaining to and/or generated based on user's positioning information, which may be obtained from the location processor 306. In this regard, the 3D controller 308 may incorporate the 3D related video information with the information pertaining to determined viewing directions associated with particular viewer's eyes.

The video processing core 310 may comprise suitable logic, circuitry, interfaces and/or code that may be operable to perform video processing operations. The video processing core 310 may be operable to process input video, which may comprise 3D video, received and/or handled by the video processing subsystem 200. The video processing core 310 may be operable to generate corresponding output video which may be playback via the display subsystem 230. In an exemplary aspect of the invention, the video processing core 310 may also support directed light stereo display, substantially as described with regard to FIG. 2. The video processing core 310 may comprise, for example, a video encoder/decoder (codec) 310, a video processor 314, a video compositor 316, and a 3D user interface (UI) generator 316.

The video codec 312 may comprise suitable logic, circuitry, interfaces and/or code for performing video encoding and/or decoding. For example, the video codec 312 may be operable to process received encoded/compressed video content, by performing, for example, video decompression and/or decoding operations. The video codec 312 may also be operable to encode and/or format video data which may be generated via the video processing core 310, as part of output video sent to the display subsystem 230. The video codec 310 may be operable to decode and/or encode video data formatted based on based on one or more compression standards, such as, for example, H.262/MPEG-2 Part 2, H.263, MPEG-4 Part 2, H.264/MPEG-4 AVC, AVS, VC1 and/or VP6/7/8. In an exemplary aspect of the invention, the video codec 312 may also support video coding standards that may be utilized in conjunction with 3D video, such as MPEG-2 MVP, H.264 and/or MPEG-4 advanced video coding (AVC) or MPEG-4 multi-view video coding (MVC). In instances where the compressed and/or encoded video data is communicated via transport streams, which may be received as TV broadcasts and/or local AV feeds, the video codec 312 may be operable to demultiplex and/or parse the received transport streams to extract video data within the received transport streams. The video codec 312 may also perform additional operations, including, for example, security operations such as digital rights management (DRM).

The video processor 314 may comprise suitable logic, circuitry, interfaces and/or code that may be operable to perform video processing operations on input video data, after it has been decoded and/or decompressed, to facilitate generation of corresponding output video data, which may be played via, for example, the display subsystem 230. In this regard, the video processor 314 may be operable to perform such operations as de-noising, de-blocking, restoration, deinterlacing and/or video sampling.

The video compositor 316 may comprise suitable logic, circuitry, interfaces and/or code that may be operable to generate output video data for display based on video content received and processed via the video processing core 310. The video compositor 316 may also be operable to combine the video data corresponding to received video content with additional video data, such as video data corresponding to on-screen graphics, secondary feeds, and/or user interface related video data. The video compositor 316 may also perform additional video processing operations, to ensure that generated output video steams may be formatted to suit the display subsystem 230. In this regard, the video compositor 316 may be operable to perform, for example, motion estimation and/or compensation, frame up/down-conversion, cropping, and/or scaling.

In operation, the video processing subsystem 200 may be operable to handle processing of video content, to facilitate video display operations based thereon via the display subsystem 230 for example. In this regard, the video processing subsystem 200 may be operable to receive video content, which may be read from storage devices or delivered via broadcasts, and may perform, via the video processing core 310, various video operations on the received video content. Exemplary video processing operations may comprise video encoding/decoding, ciphering/deciphering, de-noising, de-blocking, restoration, deinterlacing, scaling, and/or sampling. The video processing subsystem 200 may be operable to handle 2D as well as 3D video content. In this regard, in instances where the video data handled by the video processing subsystem 200 comprise 3D video content, the video processing core 310 may be utilized to generate 3D output data that may be played and/or viewed via the display subsystem 230. For example, the video processor 314 may generate, based on the video data decoded via the video codec 312, corresponding stereoscopic left and right view video sequences, which may be composited via the video compositor 316 into the output stream sent to the display subsystem 230. For example, the input video handled via the video processing subsystem 200 may comprise 3D video content, such as stereo 3D video. In this regard, the input video may comprise multiple view streams, which may comprise, for example, left eye view stream and right view streams, which may be utilized to generate different images for the right and left eyes to form 3D perception. During stereo-mode operations, the video codec 312 may be utilized to decode each of the view streams in the input video. The video processor 314 may determine how to control operations of the display subsystem 230 to correlate it with viewing by each of viewer's right and left eyes, and/or how to configure operations of the display subsystem 230 based on the right and the left video streams. The video compositor 316 may then utilize the configuration and/or control information generated by the video processor 314 to create and/or form different view streams. During mono-mode operations, in which the input video may only comprise 2D video, video codec 312 may be utilized to decode the input video, and the video processor 314 may still determine how to control operations of the display subsystem 230 to correlate it with separate viewing by each of viewer's right and left eyes. The display subsystem 230 may be configured, however, via the video compositor 316 to display separate views streams but with the identical video (e.g. color and/or intensity) values.

In various embodiments of the invention, the video processing subsystem 200 may support use of the display subsystem 230 to provide directed stereo display operations, which may enable autonomous 3D viewing, that is, without requiring use of any additional auxiliary devices such as 3D glasses. In this regard, during directed stereo display operations, light or beams, corresponding to the displayed video content for example, may be emitted by the screen 232 of the display subsystem 230 in a plurality of particular and narrow spatial directions, which may enable displaying a plurality of concurrent directional views, each of which may be utilized in a unique sequence of images. In other words, the display subsystem 230 may be configured to form a plurality of directional perception views, which may be utilized to concurrently convey different video viewing perceptions at particular spatial directions.

In an exemplary embodiment of the invention, the screen 232 of the display subsystem 230 may comprise a plurality of screen elements, each of which may support generating and/or forming separate visual perception in different directions relative to the screen 232. The screen elements may be configured to form the directional perception views based on positioning information associated with users of the video device 100, which may be determined relative to the screen 232. In this regard, at least some of the directional perception views may be correlated with the viewing angles associated with each of particular viewer's eyes. Accordingly, during 3D video display operations, the video processing subsystem 200 may adaptively configure screen elements in the screen 232 to utilize particular directional perception views to conveying images corresponding to each of the right eye and the left eye, which when combined would create 3D perception. In instances where the displayed video content comprises 2D video rather than 3D video, the directional views associated with each of user's right eye and left eye may be utilized to convey identical images, which may result in 2D perception rather than 3D perception.

In an exemplary embodiment of the invention, in order to ensure that the directed stereo display of video is formed properly, the location and/or orientation of users, such as user 102, relative to the display subsystem 230 may be determined, using the user locator subsystem 220. In this regard, the user location and/or orientation relative to the location and/or orientation of video processing subsystem 200 and/or the display subsystem 230. The user location and/or orientation may be determined based on information generated by suitable sensors that may be integrated into and/or coupled to the user locator subsystem 220. In this regard, these sensors may enable locating viewers, and/or determining the location and/or orientation of the viewers relative to the video processing subsystem 200 and/or the display subsystem 230. Exemplary sensors may comprise, for example, cameras, optical and/or infrared scanners, Z-depth sensors, and/or biometric sensors. In this regard, the sensors may be utilized to locate, identify, and/or track the user, and may generate corresponding positioning data associated therewith. User location and/or orientation data may be utilized, for example, via the location processor 306 and/or the 3D controller 308 to determine and/or control forming of directed stereo projections based on location and/or orientation of the users. To ensure that the directed stereo display is maintained, viewer movement may be continually tracked and/or monitored, and display operations may be controlled and/or readjusted based by modifying directional viewing settings corresponding to the user. Tracking and/or monitoring of user movement and/or actions may be performed via the user locator subsystem 220.

FIG. 3B is a block diagram illustrating an exemplary user locator subsystem of a video device that may support directed stereo display, in accordance with an embodiment of the invention. Referring to FIG. 3B, there is shown the user locator subsystem 220.

The user locator subsystem 220 may comprise a main processor 322, a system memory 334, a video processor 336, a location estimator 338, and an object identifier 340. The user locator subsystem 220 may also comprise pair of stereoscopic cameras 342A and 342B. In an exemplary aspect of the invention, the user locator subsystem 220 may support autonomous 3D video display operations, utilizing directed light stereo display, substantially as described with regard to FIG. 2. In this regard, the user locator subsystem 220 may be integrated into the video device 100, for example, to enable detecting and/or tracking users of the video device 100, and/or generating positional information associated therewith.

The main processor 322 may be similar to the main processor 302 of FIG. 3A. In this regard, the main processor 322 may process information, control and/or manage operations of the user locator subsystem 220, and/or handle tasks and/or applications performed therein. In this regard, the main processor 322 may configure and/or control operations of various components of the user locator subsystem 220, by utilizing control signals for example.

The system memory 334 may be similar to the system memory 304 of FIG. 3A. In this regard, the system memory 334 may be utilized for permanent and/or non-permanent storage, buffering and/or fetching of data, code and/or other information which may be used, consumed and/or processed in the user locator subsystem 220. The system memory 334 may store, for example, configuration data, which may comprise parameters and/or code, comprising software and/or firmware, but the configuration data need not be limited in this regard.

The location estimator 338 may comprise suitable logic, circuitry, interfaces and/or code that may be operable to perform location and/or tracking related operations. In this regard, the location estimator 338 may be operable to determine or estimate the location of viewers of the video device 100, based on information generated from images captured by the cameras 342A and/or 342B for example. The location estimator 338 may be operable to, for example, determine and/or estimate separation or distance between a particular user and the screen 232, and/or to determine and/or estimate orientation of a user relative to the screen 232, which may be utilized to determine user's viewing angle in relation to the screen 232.

The object identifier 340 may comprise suitable logic, circuitry, interfaces and/or code that may be operable to identify objects during user location operations, and/or to generate information related thereto. In this regard, the object identifier 340 may be utilized to identify various objects in images captured by the cameras 342A and/or 342B. For example, the object identifier 340 may be utilized to identify users, and/or particular parts thereof such as viewers' eyes, and/or to generate information associated therewith. In this regard, eye related information may comprise location information relative to the display subsystem 230. This may comprise information pertaining to distance, position, orientation, and/or viewing angle associated with each of the eyes. While the location estimator 338 and/or object identifier 340 is shown as a separate component within the user locator subsystem 220, the invention need not be so limited. For example, the location estimator 338 and/or object identifier 340 may be integrated into other components of the user locator subsystem 220, and/or functions or operations described herein with respect to the location estimator 338 and/or object identifier 340 may be performed by other components of the user locator subsystem 220, such as the main processor 322 for example.

The video processor 336 may comprise suitable logic, circuitry, interfaces and/or code that may be operable to perform video processing operations in the user locator subsystem 220, such as during processing of images captured via the cameras 342A and/or 342B for example. The video processor 336 may be operable to process captured image data, and may perform various related operations, such as, for example, compressing and/or decompressing the data, encoding and/or decoding the data, and/or filtering the data to remove noise and/or otherwise improve quality of the data. Furthermore, the video processor 336 may also be operable to generate information that may be utilized to enable three-dimensional (3D) tracking of users. In this regard, the video processor 336 may be operable to generate and/or process depth information based on handling of images from both of the stereoscopic cameras 342A and 342B.

In operation, the user locator subsystem 220 may be utilized to detect users of video device 100, who may view video content displayed directed by the video device and/or via display device that may be coupled to the video device 100, and/or to generate and/or modify corresponding positional information. In this regard, the user locator subsystem 220 may be operable to search for and/or locate users. For example, the stereoscopic cameras 342A and 342B may be utilized to captured and/or generate images corresponding to the area in space facing the screen 232. The captured images may be processed via video processor 336, and may then be analyzed by the location estimator 338 and/or the object identifier 340 to search for users and/or to determine corresponding user positioning information. In this regard, the object identifier 340 may search content of the captured images for objects matching preconfigured description associated with users. In addition, the location estimator 338 may determine user positioning information, such as distance to and/or orientation relative to the screen 232 based on spatial data generated or estimated from the 3D content corresponding to captured stereoscopic images. In an exemplary aspect of the invention, the positional information may also comprise additional information that may be necessary for directed stereo display operations. For example, the positional information may comprise information pertaining to location and/or orientation of each of the viewers' eyes relative to the screen. The stereoscopic cameras 342A and 342B may also be utilized to continue tracking, spatially and/or temporally, movement of the detected users

FIG. 3C is a block diagram illustrating an exemplary screen which may support directed stereo display, in accordance with an embodiment of the invention. Referring to FIG. 3C, there is shown the display subsystem 230.

The display subsystem 230 may comprise the screen 232, which may support directed stereo display operations. In this regard, the screen 232 may comprise a plurality of screen elements 350, each of which may be configured and/or controlled separately to facilitate directed stereo display by enabling configuring a plurality of separate light emissions, each of which conveying different video perception, which may result from varying video information such as brightness and/or color. The number and/or distribution of screen elements 350 may correspond to the maximum display resolution supported by, and/or associated with the screen of the video device 100. For example, in instances where the screen 232 supports a maximum display resolution corresponding to video format 1080p (full HDTV), the screen 232 may be configured to comprise 1920×1080 screen elements 350.

In an exemplary embodiment of the invention, each screen element 350 may comprise a micro-lens 352 covering an array of sub-pixels 354. In this regard, the screen elements 350 may be designed and/or manufactured such that light emitted by each of the elements of the array of sub-pixels 354 may only be allowed, via the micro-lens 352, to be focused in certain narrow direction. Focusing characteristics of each of screen element 350 may depend on, for example, positioning and/or placement of the micro-lens 352 and/or the array of sub-pixels 354, and/or the separation between the micro-lens 352 and the array of sub-pixels 354. Characteristics of the directed beam emissions from the elements of the array of sub-pixels 354 may also be dependent on, and/or may be modified based on the focal length associated with the micro-lens 352 and/or the number and distribution of the elements in the array of sub-pixels 354. Furthermore, each of the elements in the array of sub-pixels 354 may be controlled and/or configured separately. In this regard, directionally of video display via each screen element 350 may depend on selection of certain elements of the array of sub-pixels 354 that that are activated in each screen element 350. For example, once positions of viewer's left and right eyes, relative to the screen 232, are determines, it may be determined which of the elements of the array of sub-pixels 354 best line up with the viewer's left-eye and right-eye, and these elements may then be activated to create video flows directed to the viewer's left-eye and right-eye. Furthermore, to create stereo video display, the elements of the array of sub-pixels 354 that are activated for display to the viewer's left-eye and right-eye may be configured and/or controlled separately, to enable generating unique video perception to each of the viewer's left-eye and right-eye. In this regard, controlling and/or configuring elements in the array of sub-pixels 354 may comprise setting video information, such as brightness and/or color related information, associated with each of the element separately and/or independently of remaining elements. Controlling and/or configuring elements of the array of sub-pixels 354 may also comprise completely turning off certain elements of the array of sub-pixels 354.

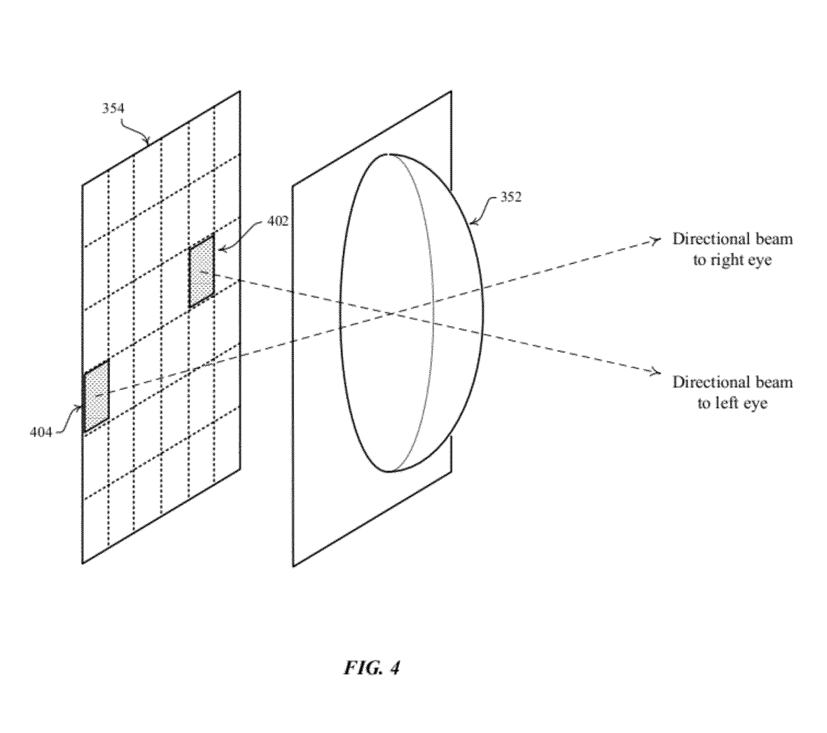

FIG. 4 is a block diagram that illustrates an exemplary use of a micro-lens element in a directed stereo display capable screen to provide directional light emissions, in accordance with an embodiment of the invention.

The screen element 350 may be configured to concurrently form two separate viewing perceptions directed to users' left eye and right eye, such as left eye 104A and right eye 104B of user 102, in the context of directed stereo display operations via the screen 232. In this regard, the video processing subsystem 200 may determine which of the elements of the array of sub-pixels 352 may be best suited to form the directional light emissions in the directions of the users' right eye 104B and left eye 104A. This may be achieved by determining, based on user positioning information, one or more elements the array of sub-pixels 352 that may be lined up, using focusing characteristics of overlaying micro-lens 352 for example, with each of the user's right eye and the left eye. In this regard, the screen element 350 may be configured to performed directional display based on the type of video content in input video. The input video may comprise 3D video content, such as stereo 3D video. In this regard, the input video comprise multiple view streams, which may comprise, for example, left eye view stream and right view streams, which may be utilized to generate different images for the right and left eyes to form 3D perception. In this regard, during stereo-mode operations, the video codec may be utilized to decoding each of the view streams in the input video, the video processor may determine which of the sub-pixels under each of the micro-lenses correspond to each of the right and left eyes, and may determine how to configure each of these sub-pixels under each of the mirco-lenses based on the right and the left video streams, and the video compositor may activate accordingly corresponding pixels. During mono-mode operations, in which the input video may only comprise 2D video, video codec may be utilized to decode the input video, and the video processor may still determine which of the sub-pixels may correspond to each of the right and left eyes. These sub-pixels, however, would be activated and/or configured via the video compositor with the identical video (e.g. color and/or intensity) values. For example, the video compositor 316 may select pixel element 404 based on a determination that it may be the best suited element in the array of sub-pixels 354 to form the viewing perception associated with the right eye 104B. Furthermore, the video compositor 316 may select pixel element 402 based on a determination that it may be the best suited element in the array of sub-pixels 354 to form the viewing perception associated with the left eye 104A. Furthermore, to facilitate 3D perception, such as when to display 3D content, the video processing subsystem may be operable to configure pixel elements 402 and 404 variably to form, concurrently, varying perception corresponding to left view and right view, respectively. This may comprise configuring each of the pixel elements 402 and 404 with different video control signals, corresponding to different video information (e.g. brightness and color). In instances where the positioning information associated with the user may be changed, due to spatial movement of the user relative to the screen 232 for example, the screen element 350 may be reconfigured such that other and/or different element pixels may be selected for use in forming directional viewing perception corresponding to the user's updated positioning information. For example, video values used during the display operations, such color and/or intensity, for each pixel in the array 354 may be determined and/or defined based on video values of the corresponding images in the input video, regardless of whether it is mono or stereo video. For example, two sub-pixels (e.g. 404 and 402) may be activated under each micro-lens 352 may be active, and these sub-pixels may be illuminated with the colors and intensity defining the perceived color and intensity that would've been assigned to whole pixel if a traditional display may have been used. These two sub-pixels may be selected such that there positioned may line up with each of the viewer's left and right eyes through the center of the micro-lens 352. When viewer's eyes positions change, there may be no need to change and/or recalculate the color and intensity of activated sub-pixels. Rather, only selections of the activated sub-pixels may be modified, by recalculating the index of selected sub-pixels, based on spatial position of the viewer eyes with respect to the screen 232.

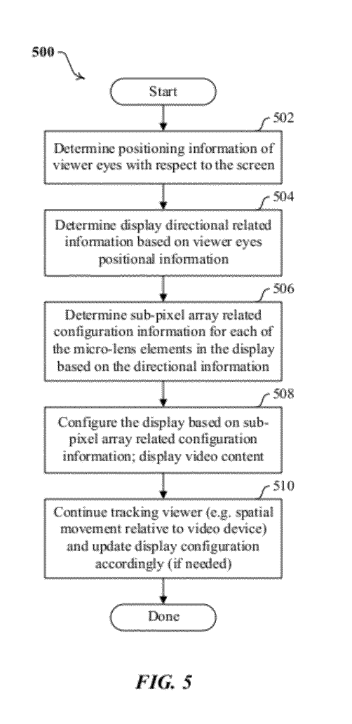

FIG. 5 is a flow chart that illustrates exemplary steps for performing directed light stereo display, in accordance with an embodiment of the invention. Referring to FIG. 5, there is shown a flow chart 500 comprising a plurality of exemplary steps that may be performed to enable performing directed light stereo display during video processing.

In step 502, the positioning information associated with viewer's left and right eye may be determined. In this regard, the viewer's left and right eye may be determined after detecting presence of a viewer, and/or based on determination of positional information associated with the detected viewer. The viewer's eyes' positioning information may comprise information pertaining to location and/or angle of perception associated with each of the viewer's left and right eye relative to the screen utilized in displaying video content. In step 504, display directional related information may be determined based on positional information associated with viewer's left and right eyes. In step 506, sub-pixel array related configuration information for each of the micro-lens elements in the display may be determined based on the directional information. In step 508, the display may be configured based on sub-pixel array related configuration information and display video content. In step 510, viewer movements, comprising spatial movement relative to the location and/or orientation of video device, may be continually tracked, and display configuration may be updated accordingly as needed.

Various embodiments of the invention may comprise a method and system for directed light stereo display. The video device 100 may detect, via the viewer locator subsystem 220, presence of users of the video device 100, such as user 102, and may determine positioning information associated with each of the detected viewers. The viewer positioning information may comprise information specifying viewer location, distance, and/or orientation, relative to a location and/or orientation of the video device 100, or to screen 232 of the display subsystem 230 thereof. The video device 100 may determine, via the location processor 306 for example, a plurality of perception directions associated with each viewer, and display of video content via the video device 100 may be controlled, via the video processing subsystem 200, based on the determined plurality of perception directions. In this regard, the display of the video content may be adaptively controlled based on changes to one or more of the determined plurality of the perceived locations. Furthermore, controlling display of video content via the video device 100 may also comprise adaptively configuring display of video content separately in each of the plurality of perception directions.

Viewer positioning information may be determined, and/or spatial and/or temporal movement of viewers may be tracked based on information generated by one or more sensors integrated into and/or coupled to the vide device, such as the pair of stereoscopic cameras 342A and 342B. The viewer positioning information may comprise information associated with each of left eye 104A and right eye 104B of the viewer, which may comprise information pertaining to location and/or angle of perception associated with each eye relative to the video device 100, or screen 232 thereof. The plurality of perception directions may comprise perception directions corresponding to each of the right eye 104B and the left eye 104A of viewer relative to the location and/or orientation of the video device 100, or screen 232 thereof. In this regard, controlling display of video content via the video device 100 may comprise adaptively and/or separately controlling display of that video content in each of the perceptions perception directions associated with the left eye and right eye of the viewer. This may be achieved by determining and/or selecting particular elements of the array of sub-pixels 352 in each screen element 350 in screen 232 for use in displaying video content to each of the right eye 104B and the left eye 104A. Three-dimensional (3D) perception may be formed by displaying separate sequences of frames or fields associated with each of viewer's left and right eye via appropriate corresponding perception directions. For two-dimensional (2D) video content, display operation may be configured to convey identical video content in each of the perception directions associated with that viewer's right and left eyes, to form 2D perception.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for directed light stereo display.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
in a video device:
determining a plurality of perception directions associated with a viewer that views video content handled by said video device; and
controlling display of said video content based on said determined plurality of perception directions.

2. The method according to claim 1, comprising configuring said display of video content via at least some of said plurality of perception directions to generate three-dimensional (3D) perception if said video content comprises 3D video.

3. The method according to claim 1, comprising configuring said display of video content via at least some of said plurality of perception directions to generate two-dimensional (2D) perception if said video content comprises 2D video.

4. The method according to claim 1, wherein said plurality of perception directions comprises perception directions associated with eyes of said viewer.

5. The method according to claim 4, comprising adaptively and separately controlling said display of said video content in each of said perceptions perception directions associated with eyes of said viewer.

6. The method according to claim 1, comprising determining said plurality of perception directions based on positioning information associated with said viewer.

7. The method according to claim 6, comprising determining said positioning information of said viewer, and/or tracking spatial and/or temporal movement by said viewer based on information generated by one or more sensors.

8. The method according to claim 7, wherein said one or more sensors comprise stereoscopic cameras.

9. The method according to claim 6, wherein said positioning information associated with said viewer comprises information pertaining to location and/or angle of perception associated with each eye of said viewer relative to said video device.

10. A system, comprising:
one or more circuits for use in a video device, said one or more circuits being operable to:
determine a plurality of perception directions associated with a viewer that views video content handled by said video device; and
control display of said video content based on said determined plurality of perception directions.

11. The system according to claim 10, wherein said one or more circuits are operable to configure said display of video content via at least some of said plurality of perception directions to generate three-dimensional (3D) perception if said video content comprises 3D video.

12. The system according to claim 10, wherein said one or more circuits are operable to configure said display of video content via at least some of said plurality of perception directions to generate two-dimensional (2D) perception if said video content comprises 2D video.

13. The system according to claim 10, wherein said plurality of perception directions comprises perception directions associated with eyes of said viewer.

14. The system according to claim 13, wherein said one or more circuits are operable to adaptively and separately control said display of said video content in each of said perceptions perception directions associated with eyes of said viewer.

15. The system according to claim 10, wherein said one or more circuits are operable to determine said plurality of perception directions based on positioning information associated with said viewer.

16. The system according to claim 15, wherein said one or more circuits are operable to determine said positioning information of said viewer, and/or tracking spatial and/or temporal movement by said viewer based on information generated by one or more sensors.

17. The system according to claim 15, wherein said one or more sensors comprise stereoscopic cameras.

18. The system according to claim 15, wherein said positioning information associated with said viewer comprises information pertaining to location and/or angle of perception associated with each eye of said viewer relative to said video device.

19. A screen comprising a plurality of screen elements, wherein each of plurality of screen elements comprises a mirco-lens that overlays a plurality of sub-pixel elements, and each of said plurality of sub-pixel elements is separately configurable during video display operations utilizing said screen.

20. The screen of claim 19, wherein said mirco-lens of each of said plurality of screen elements is operable to direct video display by each of said plurality of sub-pixel elements in separate one of a plurality of perception directions relative to said screen.
